(19) United States
(12) Patent Application Publication
(10) Pub. No.: US 2026/0315962 A1
(43) Pub. Date: Oct. 15, 2026

(54) Sand Trap Monitoring System and Methods

(71) Applicant: Ideal Completion Services LLC, Tulsa, OK (US)

(72) Inventors: Cody S. Moore, Evanston, WY (US); Hunter S. Parker, Spring, TX (US)

(21) Appl. No.: 19/646,231

(22) Filed: Apr. 13, 2026

Related U.S. Application Data
(60) Provisional application No. 63/787,481, filed on Apr. 11, 2025.

(51) Int. Cl. B01D 21/30; B01D 21/24; G01T 1/167

(52) U.S. Cl. CPC B01D 21/302; B01D 21/245; G01T 1/167

(57) ABSTRACT

A material separation system includes a separator, an accumulation vessel configured to receive material from the separator, and a control system. The accumulation vessel includes a radiation source, a sensor, and a valve. The control system is in operable communication with the separator and/or the accumulation vessel.

### CROSS-REFERENCE TO RELATED APPLICATIONS

This application claims the benefit of priority of U.S. Provisional Application No. 63/787,481, filed Apr. 11, 2025, the entire disclosure of which is incorporated herein by reference.

### FIELD OF THE DISCLOSURE

The disclosure relates generally to the field of oil and gas extraction. More particularly, the disclosure relates to computerized processes to monitor and control sand traps, also commonly referred to as sand separators, which are commonly used in oil and gas extraction for removing sand and particulates from fluid streams to prevent erosive damage to piping, valves, and pumping equipment.

### SUMMARY

The following presents a simplified summary of the invention in order to provide a basic understanding of some aspects of the invention. This summary is not an extensive overview of the invention. It is not intended to identify critical elements of the invention or to delineate the scope of the invention. Its sole purpose is to present some concepts of the invention in a simplified form as a prelude to the more detailed description that is presented elsewhere.

According to an embodiment, a material separation system includes a separator, an accumulation vessel configured to receive material from the separator, and a control system. The accumulation vessel includes a radiation source, a sensor, and a valve. The control system is in operable communication with the separator and/or the accumulation vessel.

According to another embodiment, a material separation system includes a separator, an accumulation vessel configured to receive material from the separator, and a control system. The accumulation vessel includes a radiation source, a sensor, and a valve. The control system is in operable communication with the separator and/or the accumulation vessel. A method of using the material separation system includes measuring, via the sensor, a radiation level based on a location of the radiation source; determining, via the control system and using the radiation level, an accumulation amount of the material within the accumulation vessel; determining, via the control system, if the accumulation amount of the material within the accumulation vessel is less than a predetermined threshold; and, if the accumulation amount of the material within the accumulation vessel is equal to or greater than the predetermined threshold, actuating the valve on the accumulation vessel via the control system.

### BRIEF DESCRIPTION OF THE SEVERAL VIEWS OF THE DRAWINGS

Illustrative embodiments of the present disclosure are described in detail below with reference to the attached drawing figures.

FIG. 1 schematically shows example wells with separation systems, according to an embodiment.

FIG. 2 schematically shows an example well system with an accumulation vessel, according to an embodiment.

FIG. 3 shows a flowchart illustrating a method of using the separation system of FIGS. 1 and 2, according to an embodiment.

FIG. 4 schematically shows a control system for use with the separation systems of FIGS. 1 and 2.

### DETAILED DESCRIPTION

Fluid streams in oil and gas extraction operations are often under high pressure and carry significant amounts of sand and other particulates. The sand and particulates are erosive, and various devices have been created to separate them from the fluid. Flowback systems and sand traps and methods for monitoring the fluid streams are known in the art. Typically, these flowback systems are used after a well bore (e.g., for drilling oil, natural gas, etc.) has been established. Establishing a well bore involves injecting proppants (e.g., sand) and other fluids such as water into the well to ready it for extraction of the hydrocarbons. Before the well site can be used for regular oil/natural gas production, these excess contaminants must first be extracted. Flowback devices such as separators, including sand separators, (each of which may include a high-pressure separator and a low-pressure separator, as is known in the art) are used to extract this combination of oil, natural gas, water, and/or proppants until satisfactory amounts of water and proppants are removed from the well site. Regular oil/natural gas production may commence thereafter. The artisan understands that it is desirable to remove sand prior to entering a processing facility because sand is erosive, can damage equipment, and may create production losses.

A well site may comprise a plurality of wells. Conventionally, during flowback, each of these wells is associated with a separator device, where proppants, water, oil, and/or natural gas are separated and measured. Each well may produce different volumes and concentrations of each of these materials, and these amounts may vary over time. It is desirable to know these quantities since they may indicate the viability of each well (e.g., indicate when each well is ready for regular production by ensuring the initial flowrate is not unsuitably high and/or there is not an undue amount of sand that is being extracted). Thus, it is beneficial to monitor and measure the materials being extracted during flowback.

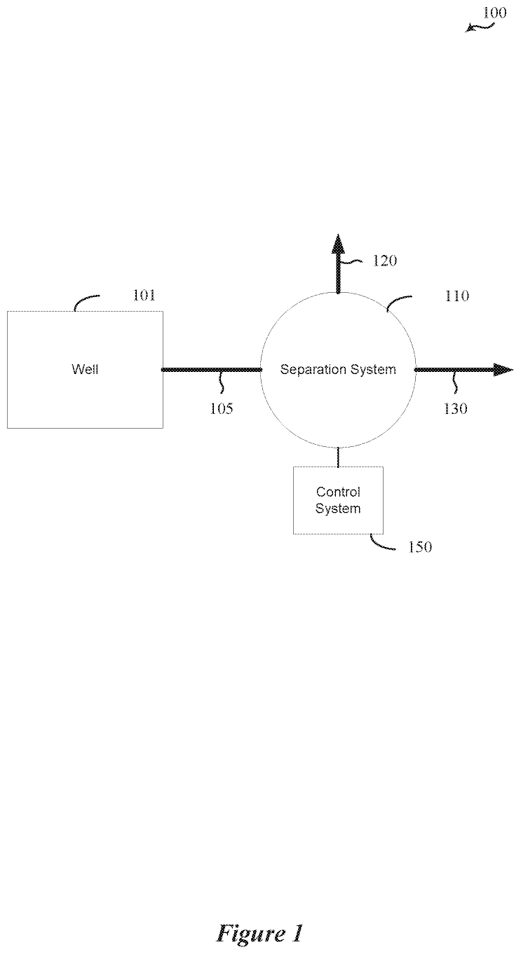

FIG. 1 schematically shows an example well system 100, according to an embodiment. In some examples, the system 100 includes a well or well(s) 101 providing material output 105 to a separation system 110. Each separation system 110 is coupled with a control system 150 providing monitoring and control for the separation system 110. While shown as a well 101 coupled to a single separation system 110, multiple wells may be paired to one or more separation systems.

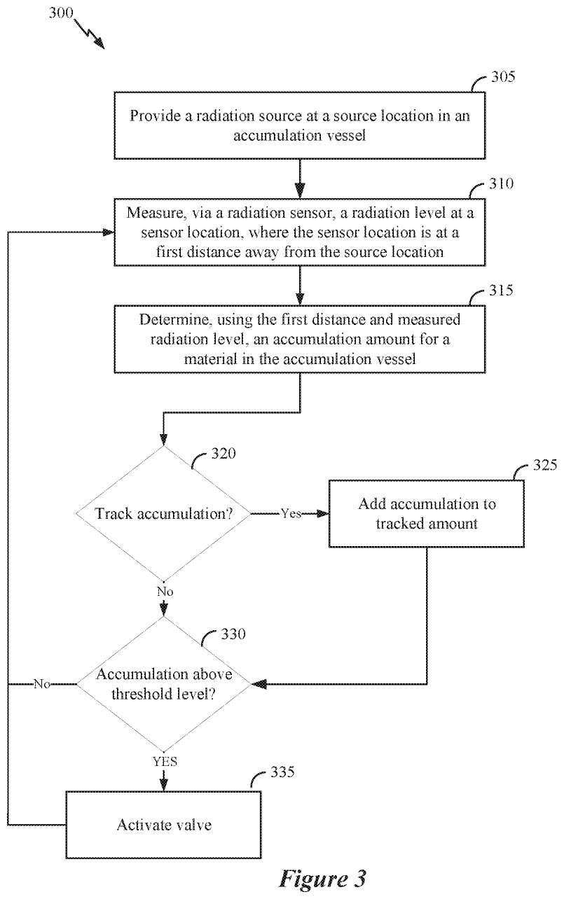

The system 110 and the control system 150 may be used to implement embodiments of a method 300 (FIG. 3), as detailed below. In some examples, the well 101 is fluidly connected to one or more storage tanks (not shown) where outputs 130 and sand outputs 120 from the separation system 110 are connected to the one or more storage tanks and are connected to sand storage tanks. In operation, the wells 101 may be used to extract material (e.g., natural gas, oil, water, proppants, such as sand and inorganic materials, etc.) from underground, and deliver said material to the separation systems 110. The separation systems 110 may process the received material by separating it into its individual components. The separation system 110, with the control system 150, may also monitor the processed material, such as measure an amount or volume of the material, identify the type of material, identify other characteristics of the material such as temperature and pressure, et cetera. A material accumulation (e.g., sand accumulation) rate may be controlled based on these characteristics in order to maximize production of hydrocarbons from the well. Once processed, the material may be routed to the one or more storage tanks via outputs 130 or via sand output 120. In some embodiments, the number of separation systems 110 employed in the process may be related to the number of active wells 101 (e.g., two separators may be used for four wells, three separators may be used for 10 wells, et cetera).

Each well 101 may comprise any suitable equipment now known or subsequently developed for extracting material, such as sand, other proppants, water, oil, natural gas, et cetera. The number of wells 101 used may be influenced by factors such as the amount of material to be extracted, size of the land that needs to be covered, size and characteristics of the reservoir, et cetera. Each of the wells 101 may be in selective communication with more than one of a plurality of separation systems 110.

The separation systems 110 may comprise any suitable equipment now know or subsequently developed for receiving material, separating material, and measuring characteristics of the material extracted from the wells 101. The separation systems 110 may be coupled to one or more storage tanks using the outputs 130 and sand output 120 such that the material processed by the separation systems 110 may be stored therein. In embodiments, the separation systems 110 may be configured to route different constituents of the extracted material to different storage tanks via the outputs 130 and sand output 120 (e.g., the separation systems 110 may route oil to one storage tank, natural gas to another storage tank, water and/or proppants to yet another storage tank, et cetera). Alternately or additionally, the separation system 110 may be configured to route one or more constituents directly to a sales line to a production facility. One or more of the separation system 110 may have associated therewith a Human Machine Interface (HMI). In operation, the HMIs may house at least in part the control system 150 and/or be communicatively coupled to the control system 150, and may allow a user to manipulate the operation and/or the settings of the system 100, as will be described in greater detail below. The separation system 110 may make use of one or more sensors to measure the characteristics of the extracted material, e.g., the pressure, temperature, flow rate, density, etc., thereof.

Each of the separation system 110 may be fluidly coupled to one or more wells 101 as chosen by the operator and/or the control system 150. Using the above-described techniques and their embodiments, a plurality of wells 101 may be accurately monitored using a plurality (e.g., a relatively smaller plurality) of separation systems 110. While barrels of oil are used as the data point in exemplary embodiments herein, it is to be understood that other values and materials may likewise be employed. For example, alternately or in addition, pressure, temperature, and/or flow rate may be used. The artisan would also understand that while these techniques, methods, and systems are illustrated using oil, these same techniques, systems, and methods may be applied towards monitoring other materials, such as water, proppants (e.g., sand), and/or natural gas.

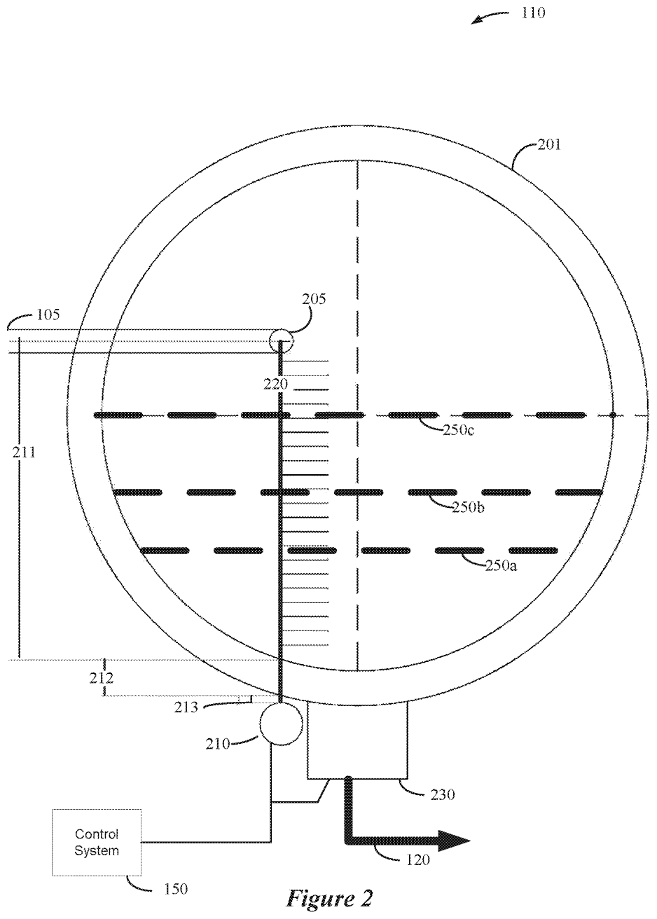

FIG. 2 schematically shows an example accumulation vessel in a separation system, according to an embodiment. For example, the separation system 110 includes an accumulation vessel 201, which may include an accumulation vessel for sand or other materials. In some examples, the vessel 201 is fluidly coupled to the well(s) 101 shown in FIG. 1 via material output 105. In some examples, the material output 105 provides pressurized material (material is provided at 5 kilopound per square inch (KSI)). In some examples, the separation system 110 is a sand separator which separates out material (e.g. sand) which accumulates in a spherical section of the accumulation vessel 201 while providing other materials (e.g., oil, natural gas, etc.) as separated materials via outputs 130 shown in FIG. 1. In some examples, material accumulates in the vessel 201 at different heights inside the vessel, such as at a first time material may accumulate at accumulation level 250a, at a second and third later time, material may accumulate to accumulation levels 250a, 250b, and 250c in the vessel 201. In some examples, in order to monitor and control the accumulation level in the vessel 201 and system 110, the control system 150 may communicate with a sensor 210 and a valve 230 as to monitor and control the accumulation levels in the vessel 201.

For example, the vessel 201 may include a radiation source at a source 205 located in the accumulation vessel. In some examples, the source 205 is a radioactive material that emits a radiation profile. For example, the source 205 may include Cesium 137. In some examples, the system 110 also includes radiation sensor 210 located at sensor location at a given distance 220 away from the source 205. For example, the sensor 210 may include a distance 211 between the source and an inner wall of the vessel, a distance 212 of a thickness of the vessel 201 and a distance 213 between the outer wall of the vessel and the sensor 210. In some examples, the distance 220 is associated with a known radiation profile from the source 205 to the sensor 210. For example, when the vessel 201 is empty, the sensor 210 measures a baseline radiation level from the source 205.

In some examples, the system 150 may also measure, via the radiation sensor 210 a radiation level as the system 110 is functioning. For example, as material begins to accumulate in the vessel 201 the system 150 may take periodic radiation measurements from the sensor 210. In some examples, the system 150 also determines, using the first distance and the measured radiation levels, an accumulation amount for a material in the accumulation vessel. For example, at a first time, the sensor 210 may read or provide a first radiation level, where the radiation measured or the first radiation level, along with the physical properties of the material (e.g., sand has a 1.9 g/cm³ density) indicates an accumulation level such as any of the accumulation levels 250a-c or other accumulation levels inside of the vessel 201.

In some examples, using the accumulation levels and a given geometry of the vessel 201, the system 150 determines a volume of the material (e.g., sand) in the vessel 201. The volume and accumulation amounts may also be used to determine how much or what percentage of the vessel is filled as well as track a total accumulation volume for the vessel and the associated well. In some examples, when the material has accumulated to a given volume or to an accumulation level in the vessel 201, the system 150 may activate (e.g., automatically) a valve 230 to provide the accumulated material via the output 120.

FIG. 3 shows a flowchart illustrating a method of using the separation system of FIGS. 1 and 2, according to an embodiment. Method 300 begins at step 305, where the system 110 provides a radiation source at a source location in an accumulation vessel. For example, the vessel 201 may include a radiation source at a source 205 located in the accumulation vessel. In some examples, the source 205 is a radioactive material that emits a radiation profile. For example, the source 205 may include Cesium 137. In some examples, the system 110 also includes radiation sensor 210 located at sensor location at a given distance 220 away from the source 205. For example, the sensor 210 may include a distance 211 between the source and an inner wall of the vessel, a distance 212 of a thickness of the vessel 201 and a distance 212 between the outer wall of the vessel and the sensor 210. In some examples, the distance 220 is associated with a known radiation profile from the source 205 to the sensor 210. For example, when the vessel 201 is empty, the sensor 210 measures a baseline radiation level from the source 205.

At step 310 the system 110 measures, via a radiation sensor, a radiation level at a sensor location, where the sensor location is at a first distance away from the source location. For example, as material begins to accumulate in the vessel 201 the system 150 may take periodic radiation measurements from the sensor 210. In some examples, the system 150 also determines, using the first distance and the measured radiation levels, an accumulation amount for a material in the accumulation vessel. For example, at a first time, the sensor 210 may read or provide a first radiation level, where the radiation measured or the first radiation level, along with the physical properties of the material (e.g., sand has a 1.9 g/cm³ density) indicates an accumulation level such as any of the accumulation levels 250a-c or other accumulation levels inside of the vessel 201.

At step 315 the system 110 determining, using the first distance and measured radiation level, an accumulation amount for a material in the accumulation vessel. In some examples, using the accumulation levels and a given geometry of the vessel 201, the system 150 determines a volume of the material (e.g., sand) in the vessel 201.

At step 320 the system 110 determines whether to track an overall accumulation. At step 325, the system adds the determined accumulation to the tracked amount.

At step 330, the system determines whether the accumulation is at a threshold level. In some examples, when the material has accumulated to a given volume or to an accumulation level in the vessel 201, the system 150 at step 335 may activate a valve 230 to provide the accumulated material via the output 120.

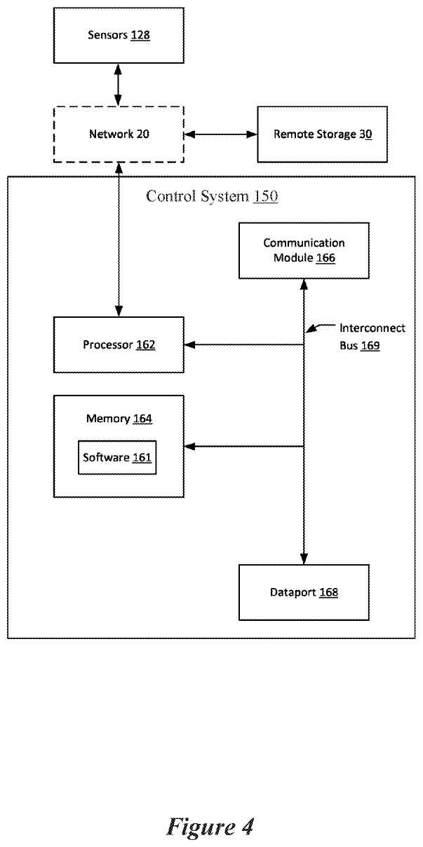

FIG. 4 is a functional block diagram of the control system 150 which may be used to implement the various methods according to the different aspects of the present disclosure. The control system 150 may be, for example, a smartphone, a laptop computer, a desktop computer, a flexible circuit board, or other computing device whether now known or subsequently developed. In embodiments, the computing system is housed at least in part within one or more of the separation systems 110; in other embodiments, the computing system is remote from the separation systems 110 and in data communication therewith. The control system 150 comprises a processor 162, the memory 164, a communication module 166, and a dataport 168. These components may be communicatively coupled together by an interconnect bus 169. A user may interact with the control system 150 via the HMIs located at the separation systems 110, for example. The artisan will understand the HMIs may comprise input and output devices, e.g., a touch screen, a keyboard, a display, et cetera.

The processor 162 may include any processor used in smartphones and/or other computing devices, including an analog processor (e.g., a Nano carbon-based processor) or a digital processor. In certain embodiments, the processor 162 may include one or more other processors, such as one or more microprocessors, and/or one or more supplementary co-processors, such as math co-processors.

The memory 164 may include both operating memory, such as random access memory (RAM), as well as data storage, such as read-only memory (ROM), hard drives, optical, flash memory, or any other suitable memory/storage element. The memory 164 may include removable memory elements, such as a CompactFlash card, a MultiMediaCard (MMC), and/or a Secure Digital (SD) card. In certain embodiments, the memory 164 includes a combination of magnetic, optical, and/or semiconductor memory, and may include, for example, RAM, ROM, flash drive, and/or a hard disk or drive. The processor 162 and the memory 164 each may be located entirely within a single device, or may be connected to each other by a communication medium, such as a USB port, a serial port cable, a coaxial cable, an Ethernet-type cable, a telephone line, a radio frequency transceiver, or other similar wireless or wired medium or combination of the foregoing. For example, the processor 162 may be connected to the memory 164 via the dataport 168.

The communication module 166 may be configured to handle communication links between the control system 150 and other external devices or receivers, and to route incoming/outgoing data appropriately. For example, inbound data from the dataport 168 may be routed through the communication module 166 before being directed to the processor 162, and outbound data from the processor 162 may be routed through the communication module 166 before being directed to the dataport 168. The communication module 166 may include one or more transceiver modules configured for transmitting and receiving data, and using, for example, one or more protocols and/or technologies, such as GSM, UMTS (3GSM), IS-95 (CDMA one), IS-2000 (CDMA 2000), LTE, FDMA, TDMA, W-CDMA, CDMA, OFDMA, Wi-Fi, WiMAX, 5G, or any other protocol and/or technology.

The dataport 168 may be any type of connector used for physically interfacing with a smartphone, computer, and/or other devices, such as a mini-USB port or an IPHONE®/IPOD® 30-pin connector or LIGHTNING® connector. In other embodiments, the dataport 168 may include multiple communication channels for simultaneous communication with, for example, other processors, servers, and/or client terminals.

The memory 164 may store instructions for communicating with other systems, such as a computer. The memory 164 may store, for example, a program (e.g., computer program code) adapted to direct the processor 162 in accordance with the embodiments described herein. The instructions also may include program elements, such as an operating system. While execution of sequences of instructions in the program causes the processor 162 to perform the process steps described herein, hard-wired circuitry may be used in place of, or in combination with, software/firmware instructions for implementation of the processes of the present embodiments. Thus, unless expressly noted, the present embodiments are not limited to any specific combination of hardware and software.

In embodiments, the memory 164 includes software 161. The software 161 may contain machine-readable instructions configured to be executed by the processor 162. The software 161 may, for example, process data obtained from the sensor 128. In embodiments, the software 161 may cause the control system 150 to dynamically respond to a reading obtained by the sensor 128.

In embodiments, the memory 164 may contain a machine learning system or program configured to carry out one or more of the techniques and methods described herein. As an example, a machine learning program may be used by the control system 150 to recognize various operating conditions of the system 100, and to formulate a response to said detections (e.g., by modifying the interpolated value calculated from the measured data set). The machine learning analysis may be provided on behalf of any number of machine learning algorithms and trained models, including but not limited to deep learning models (also known as deep machine learning, or hierarchical models) that have been trained to perform image recognition tasks. Machine learning is used to refer to the various classes of artificial intelligence algorithms and algorithm-driven approaches that are capable of performing machine-driven (e.g., computer-aided) identification of trained structures, and deep learning is used to refer to a multiple-level operation of such machine learning algorithms using multiple levels of representation and abstraction. The artisan will understand that the role of the machine learning algorithms that are applied, used, and configured as described may be supplemented or substituted by any number of other algorithm-based approaches, including variations of artificial neural networks, learning-capable algorithms, trainable object classifications, and other artificial intelligence processing techniques.

The control system 150 may be in data communication with a remote storage 30 over a network 20. The network 20 may be a wired network, a wireless network, or comprise elements of both. In embodiments, the network 20 may communicatively link one or more components of the flowback monitoring system 100. For example, the sensor 128 may be communicatively linked to the control system 150 via the network 20 for the exchange of information therebetween. The remote storage 30 may be, for example, the “cloud” or other remote storage in communication with other computing systems. In embodiments, data (e.g., readings obtained by the sensors 128 and the separation systems 110, and the dynamic responses of the control system 150 thereto) may be stored in the remote storage 30 for analytics.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

What is claimed is:

1. A material separation system, comprising:
a separator;
an accumulation vessel configured to receive material from the separator, the accumulation vessel comprising:
a radiation source;
a sensor; and
a valve; and
a control system in operable communication with the separator and/or the accumulation vessel.

2. The system of claim 1, wherein the radiation source is located on an inner surface of the accumulation vessel.

3. The system of claim 2, wherein the radiation source is a radioactive material that emits a radiation profile.

4. The system of claim 3, wherein the radioactive material is Cesium 137.

5. The system of claim 1, wherein the sensor is a radiation sensor.

6. The system of claim 5, wherein the radiation sensor is configured to periodically measure a radiation level within the accumulation vessel.

7. The system of claim 6, wherein the valve is configured to actuate when the radiation level reaches a predetermined threshold.

8. The system of claim 7, wherein the valve is automatically actuated.

9. The system of claim 1, wherein the control system comprises a human machine interface communicatively coupled to the control system, wherein the human machine interface comprises an input device.

10. The system of claim 1, wherein the sensor comprises a plurality of sensors, and wherein at least one sensor of the plurality of sensors is a radiation sensor and another sensor of the plurality of sensors is selected from the list consisting of a thermometer, a pressure transducer, a flowmeter, and a densitometer.

11. The system of claim 1, wherein the separation system is configured to route material directly to a sales line.

12. The system of claim 1, wherein the accumulation vessel is at least partially spherical.

13. The system of claim 12, wherein the material accumulates in the spherical portion of the accumulation vessel.

14. A method of using a separation system, the separation system comprising:
a separator;
an accumulation vessel configured to receive material from the separator, the accumulation vessel comprising:
a radiation source;
a sensor; and
a valve; and
a control system in operable communication with the separator and/or the accumulation vessel;
the method comprising:
measuring, via the sensor, a radiation level based on a location of the radiation source;
determining, via the control system and using the radiation level, an accumulation amount of the material within the accumulation vessel;
determining, via the control system, if the accumulation amount of the material within the accumulation vessel is less than a predetermined threshold; and
if the accumulation amount of the material within the accumulation vessel is equal to or greater than the predetermined threshold, actuating the valve on the accumulation vessel via the control system.

15. The method of claim 14, further comprising the step of storing the determined accumulation amount in memory in the control system.

16. The method of claim 14, wherein the radiation source is located on an inner surface of the accumulation vessel.

17. The method of claim 16, wherein the radiation source is a radioactive material that emits a radiation profile.

18. The method of claim 17, wherein the radioactive material is Cesium 137.

19. The method of claim 14, wherein the accumulation vessel is at least partially spherical.

20. The method of claim 14, wherein the sensor comprises a plurality of sensors, and wherein at least one sensor of the plurality of sensors is a radiation sensor and another sensor of the plurality of sensors is selected from the list consisting of a thermometer, a pressure transducer, a flowmeter, and a densitometer.
